(19) United States
(12) Patent Application Publication
(10) Pub. No.: US 2007/0007371 A1
(43) Pub. Date: Jan. 11, 2007

(54) Under vehicle spray device

(76) Inventors: Robert Mutz, Grande Prairie (CA); Philip Sheridan, Grande Prairie (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/482,274

(22) Filed: Jul. 7, 2006

(30) Foreign Application Priority Data
Jul. 8, 2005 (CA) 2,512,376

(51) Int. Cl. B05B 3/18

(52) U.S. Cl. 239/754; 239/530

(57) ABSTRACT

An under vehicle spray device includes a body having two support wheels adapted to facilitate movement of the body along a ground surface. A spray wand is supported by the body. The spray wand has a spray nozzle end and a hand grip end. An upwardly angled spray nozzle section is positioned at the spray nozzle end. A substantially horizontally oriented mounting section is provided which has a longitudinal axis. The mounting section is mounted to the body for limited rotational movement about the longitudinal axis. This permits continuous adjustment of a lateral angle of inclination of the spray nozzle section.

### FIELD OF THE INVENTION

The present invention relates to a spray device which is used when cleaning an underside of a motor vehicle.

### BACKGROUND OF THE INVENTION

There have been various under vehicle spray devices proposed, such as: U.S. Pat. No. 5,707,104 (Chan et al 1998); U.S. Pat. No. 6,045,064 (Abraham 2000); U.S. Pat. No. 6,079,640 (Merrits 2000); and U.S. Pat. No. 6,131,831 (Lawrence 2000).

### SUMMARY OF THE INVENTION

According to the present invention there is provided an under vehicle spray device, which includes a body having at least two support wheels adapted to facilitate movement of the body along a ground surface. A spray wand is supported by the body. The spray wand has a spray nozzle end and a hand grip end. An upwardly angled spray nozzle section is positioned at the spray nozzle end. A substantially horizontally oriented mounting section is provided which has a longitudinal axis. The mounting section is mounted to the body for limited rotational movement about the longitudinal axis. This permits continuous adjustment of a lateral angle of inclination of the spray nozzle section.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of an under vehicle spray device constructed in accordance with the teachings of the present invention.

FIG. 2 is a top plan view of the under vehicle spray device illustrated in FIG. 1.

FIG. 3 is a rear elevation view of the under vehicle spray device illustrated in FIG. 1, with the hand grip section in an upright orientation.

FIG. 4 is a rear elevation view of the under vehicle spray device illustrated in FIG. 1, with the hand grip section at a lateral angle of inclination.

### DETAILED DESCRIPTION OF THE PREFERRED EMBODIMENT

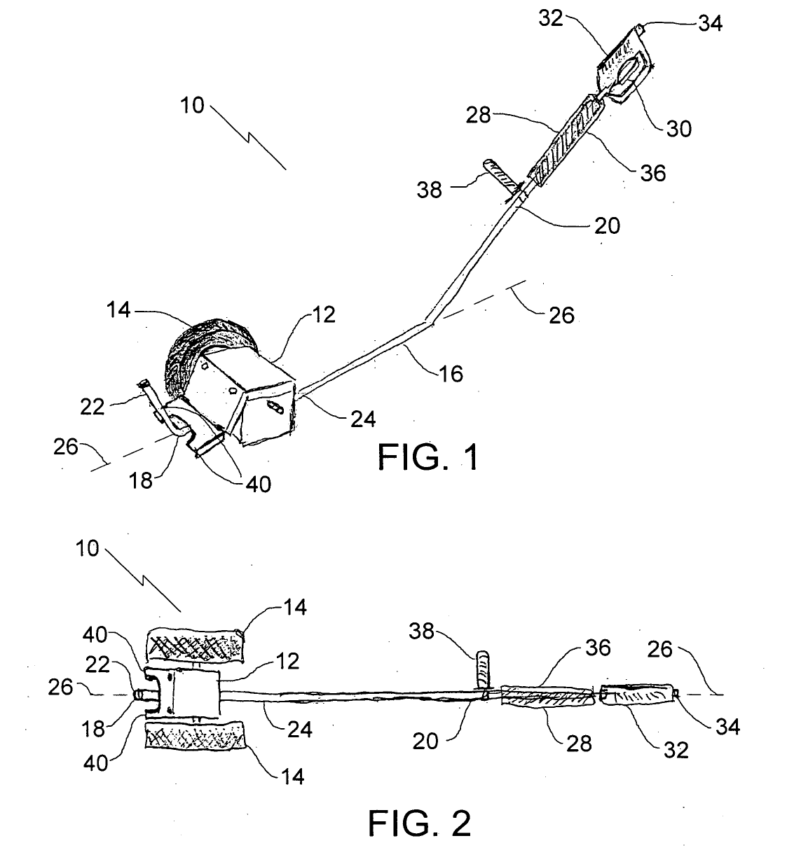

The preferred embodiment, an under vehicle spray device generally identified by reference numeral 10, will now be described with reference to FIG. 1 through 4.

Structure and Relationship of Parts:

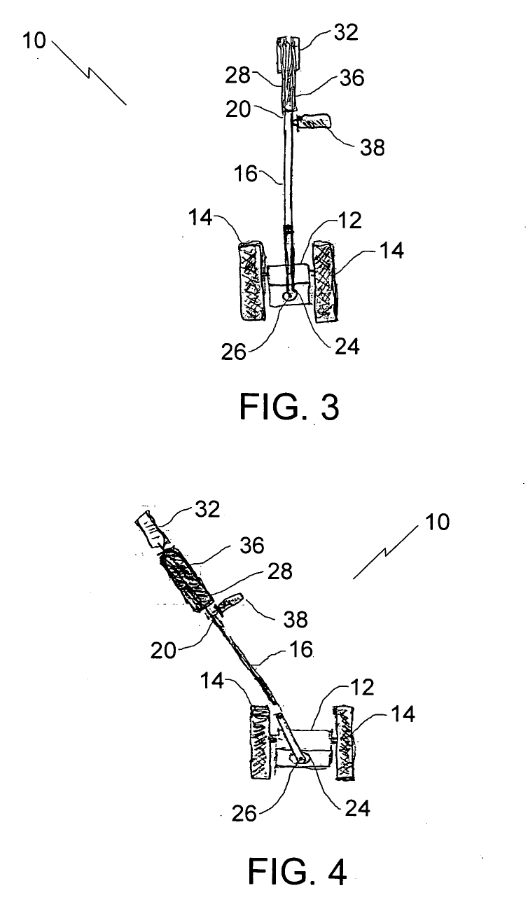

Referring now to FIG. 1, there is shown under vehicle spray device 10, a body 12 that has at least two support wheels 14 adapted to facilitate movement of body 12 along a ground surface and to permit steering of device 10. A wheel has been removed from FIG. 1 to show greater detail, with two wheels shown in FIG. 2. Referring again to FIG. 1, a spray wand 16 is supported by body 12 and has a spray nozzle end 18, a hand grip end 20, and a substantially horizontally oriented mounting section 24 having a longitudinal axis 26. There is an upwardly angled spray nozzle section 22 at spray nozzle end 18. It will be understood that, while only one spray nozzle 22 has been illustrated, more than one may be used. Mounting section 24 is mounted to body 12 for limited rotational movement about longitudinal axis 26, thereby permitting continuous adjustment of a lateral angle of inclination of spray nozzle section 22. There is an upwardly angled hand grip section 28 located at hand grip end 20. Hand grip section 28 is on a common plane with spray nozzle section 22, and includes a control lever 30 within a first hand grip 32 for controlling device 10. Referring to FIG. 2, a hose attachment 34 is located at the back of first hand grip 32. A second hand grip 36 and a third hand grip 38 are also provided in hand grip section 28. Second hand grip 36 is positioned in line with spray wand 16, while third hand grip 38 is substantially perpendicular to spray wand 16. Third hand grip 38 is adjustable along spray wand 16 and can be rotated about spray wand 16 depending on the size of the user, and whether they are left or right handed. It will be understood by those skilled in the art that other configurations of hand grips 32, 36, 38 as well as control lever 30 can be used to provide adequate results. Lateral movement imparted manually upon hand grip section 28 rotates mounting section 24 about longitudinal axis 26 resulting in lateral movement of spray nozzle section 22. Forwardly projecting stops 40 are provided on either side of spray nozzle section 22 which limit the lateral angle of inclination of spray nozzle section 22. For example, spray nozzle section 22 may have a rotation of 70 degrees to each side, or 140 degree rotation total. FIG. 3 shows hand grip section 28 in a vertical position, while FIG. 4 shows hand grip section 28 moved laterally to a rotated position. As spray nozzle end 22 moves with hand grip section 28, it is moved accordingly.

Operation:

The use and operation of under vehicle spray device 10 will now be discussed with reference to FIG. 1 through 4. Referring now to FIG. 1, under vehicle spray device 10 is assembled as discussed above. Referring to FIG. 2, a user manipulates under vehicle spray device 10 by gripping one or more of hand grips 32, 36 and 38, and rolls body 12 and therefore spray nozzle section 22 under a vehicle to be cleaned using wheels 14. Once positioned, water is provided by connecting a hose to hose connection 34. The order of connecting the hose and positioning body 12 is irrelevant. Control lever 30 is then depressed to allow water to flow through spray wand 16 and out spray nozzle end 18. Referring to FIGS. 3 and 4, handle grip end 20 may be moved in a lateral fashion such that spray nozzle end 18 is rotated about axis 26, permitting a wider cleaning range. While lever 30 is held depressed, the user may continuously reposition body 12 under the vehicle to be cleaned, and rotate spray nozzle end 18.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. An under vehicle spray device, comprising:
a body having at least two support wheels adapted to facilitate movement of the body along a ground surface;
a spray wand supported by the body, the spray wand having a spray nozzle end, a hand grip end, an upwardly angled spray nozzle section at the spray nozzle end and a substantially horizontally oriented mounting section having a longitudinal axis, the mounting section being mounted to the body for limited rotational movement about the longitudinal axis, thereby permitting continuous adjustment of a lateral angle of inclination of the spray nozzle section.

2. The under vehicle spray device as defined in claim 1, wherein there is an upwardly angled hand grip section at the hand grip end, the hand grip section being on a common plane with spray nozzle section.

3. The under vehicle spray device as defined in claim 1, wherein forwardly projecting stops are provided on either side of the spray nozzle section which limit the lateral angle of inclination of the spray nozzle section.
